(19) United States
(12) Patent Application Publication
(10) Pub. No.: US 2014/0287399 A1
(43) Pub. Date: Sep. 25, 2014

(54) SYSTEMS AND METHODS FOR LEARNING AND LEARNING ORIENTED ASSESSMENT

(71) Applicant: Infosys Limited, Bangalore (IN)

(72) Inventors: Subraya Beleyur Manjappa, Mysore (IN); Manjunatha Prasanna Sathyanarayana, Mysore (IN); Meenakshi Sahasranaman, Mysore (IN); Rengarajan Ramanujam, Mysore (IN); Amit Purohit, Indore (IN); Anooja Mary Jacob, Mysore (IN)

(73) Assignee: Infosys Limited, Bangalore (IN)

(21) Appl. No.: 14/180,240

(22) Filed: Feb. 13, 2014

(30) Foreign Application Priority Data
Mar. 21, 2013 (IN) 1234/CHE/2013

(51) Int. Cl. G09B 5/08

(52) U.S. Cl. CPC G09B 5/08
USPC 434/362

(57) ABSTRACT

The technique relates to a system and method for learning and learning oriented assessment of at least one learner based on a role to be performed by the at least one learner. This technique involves identifying knowledge areas related to a particular role to be performed by the learner. Under each knowledge area different learning workflows are identified and relevant topics are mapped to the learning workflows. The performance expectation from the learner at each learning workflow level is defined. The one more challenges related to the mapped topics are created and presented to the learner to solve and a score is generated for solving the challenges. This score is compared with the predefined performance expectation to determine the learning effectiveness of the learner and a capability index is computed for the learner.

### FIELD

The present invention relates generally to learning oriented assessment or implied assessment, and in particular, to a system and method for learning and learning oriented assessment of at least one learner based on a role to be performed by the at least one learner.

### BACKGROUND

Online learning is one of the key trends in the education domain. There are several players in this domain with a host of tools, platforms, learning management systems and content providers. Learners are drowning in content and starving for knowledge. Classroom teaching is being emulated through various online mechanisms and is being scaled to learn through various devices (computers, mobile phones etc.). Assessments are done as a discrete activity and the scores decide the results of learning.

Present technology points to the existence of learning management system (LMS) and online learning system. There are two variations of the above—proprietary and open source. The learning management systems help in hosting of content and a host of online learning features. The LMS's are based on the learning theories of constructivism, constructionism, social constructivism and social behavior of humans. They help in content management and hosting, adhering to SCORM standards. They also help in creating content using various multimedia tools and in configuring assessments, building quizzes and other exam related activities. On the other hand, the online learning systems tend to democratize education by bringing education (through static content, broadcast of lectures by renowned professors, multimedia content) to the desktops of learners. They use various pedagogical approaches to deliver the content to cater to diverse learning styles, and to the pace of the heterogeneous learners. Assessment is a post learning activity in these systems. Personalized assessment and learning are done by these systems.

There are few limitations with the above mentioned systems. These include missing of customization of education to meet the specific job needs or requirements of the learner. In all the above systems assessments are explicit activities. It is also a post learning activity and is discrete in nature. Hence, assessment suffers from being a measurement tool rather than a learning tool. The above mentioned learning systems measure the user progress in terms of time spent, questions answered etc. and provide learning patterns and results. However, the assurance in an objective fashion to the learner or the stakeholder is missing. The content and assessments of the above mentioned systems are ‘one size fits all’. Mapping content specific to the learning needs is missing. If a specific course is taken up by learners with varying degrees of prior knowledge, the same content is provided.

In view of the foregoing discussion, there is a need for a learning framework which supports disciplining of contents, context based learning and implied assessment.

### SUMMARY

The present technique overcomes all the limitations mentioned above by providing a framework that supports disciplining of content, context based learning and implied assessment. The content is disciplined to align it with the learner's need.

According to the present embodiment, a method for learning and learning oriented assessment of at least one learner based on a role to be performed by the at least one learner is disclosed. The method includes identifying one or more knowledge areas related to the role of the at least one learner. The one or more learning workflows related to each of the one or more knowledge areas are identified. Further, one or more topics are mapped to the one or more learning workflows. In addition to that, a performance expectation for the at least one learner with respect to the one or more one or more learning workflows are defined based on a combination of scope, relevance and retention factors of the one or more mapped topics. After that one or more challenges for the at least one learner are created based on the one or more topics mapped to the one or more learning workflows. Then, the one or more challenges are presented to the at least one learner based on the one or more topics mapped to the one or more learning workflows. Thereafter, a score for the at least one learner with respect to each of the one or more topics is generated and learning effectiveness is determined by comparing the score with the performance expectation. Finally, a capability index for the one or more knowledge areas of the at least one learner is computed by consolidating the score achieved in each of the one or more learning workflows.

In an additional embodiment, a system for learning and learning oriented assessment of at least one learner based on a role to be performed by the at least one learner is disclosed. The system includes a knowledge area identification module, a learning workflow identification module, a topics mapping module, a performance expectation definition module, a challenge authoring module, a challenge presentation module, a score generation module, a learning effectiveness determination module and a capability index computation module. The knowledge area identification module is configured to identify one or more knowledge areas related to the role of the at least one learner. The learning workflow identification module is configured to identify one or more learning workflows related to each of the one or more knowledge areas of the at least one learner. The topics mapping module is configured to map one or more topics to the one or more learning workflows. The performance expectation definition module is configured to define a performance expectation for the at least one learner with respect to the one or more learning workflows based on a combination of scope, relevance and retention factors of the one or more mapped topics. The challenge authoring module is configured to create one or more challenges for the at least one learner based on the one or more topics mapped to the one or more learning workflows. The challenge presentation module is configured to present the one or more challenges to the at least one learner. The score generation module is configured to generate a score for the at least one learner with respect to each of the one or more topics. The learning effectiveness determination module is configured to determine learning effectiveness of the at least one learner by comparing the score with the performance expectation. The capability index computation module is configured to compute a capability index of the at least one learner by consolidating the score achieved in each of the one or more topics.

In another embodiment, a computer readable storage medium for learning and learning oriented assessment of at least one learner based on a role to be performed by the at least one learner is disclosed. The computer readable storage medium which is not a signal stores computer executable instructions for identifying one or more knowledge areas related to the role of the at least one learner, identifying one or more learning workflows related to each of the one or more knowledge areas for the role of the at least one learner, mapping one or more topics to the one or more learning workflows, defining a performance expectation for the at least one learner with respect to the one or more learning workflows based on a combination of scope, relevance and retention factors of the one or more mapped topics, for creating one or more challenges for the at least one learner based on the one or more topics mapped to the one or more learning workflows, presenting the one or more challenges to the at least one learner based on the one or more topics mapped to the one or more learning workflows, generating a score for the at least one learner with respect to each of the one or more topics, determining learning effectiveness of the at least one learner by comparing the score with the performance expectation and computing a capability index of the at least one learner by consolidating the score achieved in each of the one or more learning workflows.

### DRAWINGS

Various embodiments of the invention will, hereinafter, be described in conjunction with the appended drawings provided to illustrate, and not to limit the invention, wherein like designations denote like elements, and in which:

FIG. 1 is a computer architecture diagram illustrating a computing system capable of implementing the embodiments presented herein.

FIG. 2 is a framework under which various embodiments of the present invention can be practiced.

FIG. 3 is a flowchart, illustrating a method for learning and learning oriented assessment of at least one learner based on a role to be performed by the at least one learner, in accordance with an embodiment of the present invention.

FIG. 4 is a block diagram illustrating a system for learning and learning oriented assessment of at least one learner based on a role to be performed by the at least one learner, in accordance with an embodiment of the present invention.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Exemplary embodiments of the present invention provide a system and method for learning and learning oriented assessment of at least one learner based on a role to be performed by the at least one learner. This involves pre-learning phase, learning phase and post-learning phase. The pre-learning phase involves identifying the knowledge areas for a specific role and learning workflows associated with the identified knowledge areas for a particular role, mapping the topics to the learning workflows and setting performance expectation for the learning workflow. The pre-learning phase is followed by learning phase where the challenges are presented to the learners and the learning score is captured. In post-learning phase, the capability index of the learner is computed.

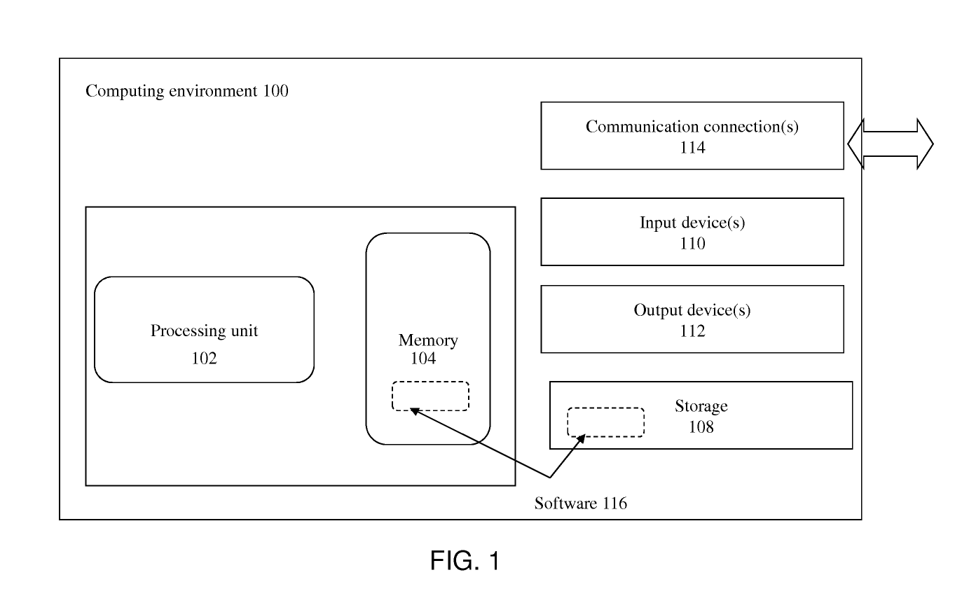

FIG. 1 illustrates a generalized example of a suitable computing environment 100 in which all embodiments, techniques, and technologies of this invention may be implemented. The computing environment 100 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 1, the computing environment 100 includes at least one central processing unit 102 and memory 104. The central processing unit 102 executes computer-executable instructions. In a multi-processing system, multiple processing units execute computer-executable instructions to increase processing power and as such, multiple processors can be running simultaneously. The memory 104 may be volatile memory (e.g., registers, cache, RAM), non-volatile memory (e.g., ROM, EEPROM, flash memory, etc.), or some combination of the two. The memory 104 stores software 116 that can implement the technologies described herein. A computing environment may have additional features. For example, the computing environment 100 includes storage 108, one or more input devices 110, one or more output devices 112, and one or more communication connections 114. An interconnection mechanism (not shown) such as a bus, a controller, or a network, interconnects the components of the computing environment 100. Typically, operating system software (not shown) provides an operating environment for other software executing in the computing environment 100, and coordinates activities of the components of the computing environment 100.

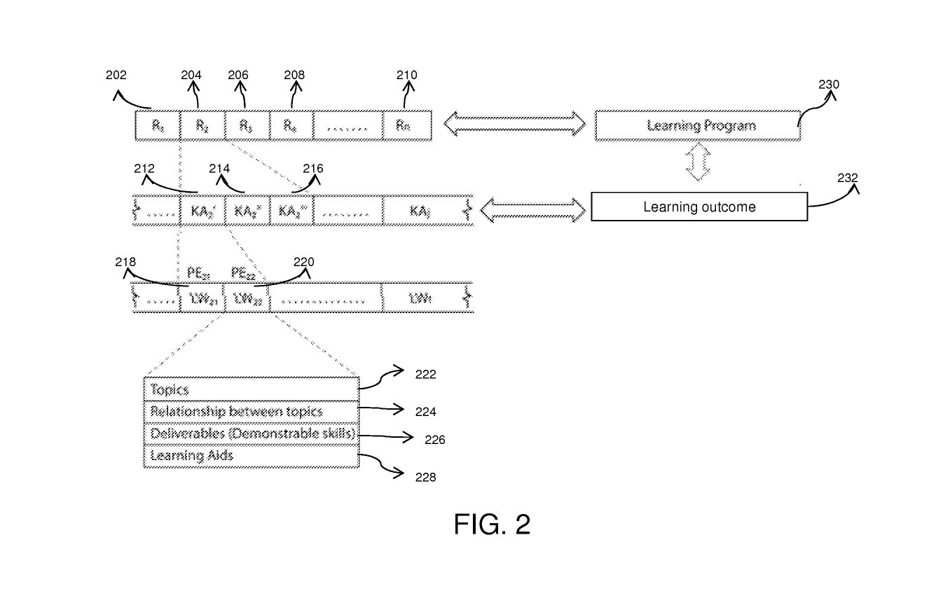

FIG. 2 is a framework under which various embodiments of the present invention can be practiced. Basically, this framework represents different terminologies and their relationship. In this figure, R₁ 202, R₂ 204, R₃ 206, R₄ 208, Rn 210 represents different roles. The learners are mapped to different roles. Role is a portfolio to demonstrate an accountable set of abilities and knowledge, limited by a set of constraints adhering to pre-defined standards. The roles are the prime concern of the learning program 230. The learning outcome 232 of a learning program 230 for a given role is an identified consequence of learning process for a learner. A learning program 230 designed for a role is expected to ensure the demonstration of accountable set of abilities and knowledge through the learning outcomes 234. More formally,

R→LP

LP={LO₁, LO₂, LO₃ . . . LOn}

where,

R denotes Role

LP denotes a learning Program designed for R

LOi denotes an identified learning outcome for a LP mapped to R.

In the figure KA₂′ 212, KA₂″ 214 and KA₂′″ 216 are different knowledge areas associated with the Role R₂ 204. The knowledge area for a role is a cluster of logically related learning outcomes comprising of tightly coupled mutually exclusive learning workflows. Further, in the figure LW₂₁ 218 and LW₂₂ 220 are different learning workflows under the knowledge area KA₂′. A learning workflow of a knowledge area is an ordered set of topics 222 for that knowledge area, relationship between the topics 224, deliverables (demonstrable skills) 226 and related learning aids 228.

LWi=(Ti, Ri, Di, Ci)

Here, Ti denotes identified topic in a knowledge area

Ri denotes relationship among the learning workflows

Di denotes identified deliverables for a learning workflow

Ci denotes the associated learning aids in multiple forms.

Each learning workflow has a certain level of expectation which is called as performance expectation on the accountable set of abilities and knowledge as envisaged by the learning workflow achieved through Implied Assessment. In the FIG. 2, PE₂₁ represents the performance expectation for the learning workflow LW₂₁ 218 and PE₂₂ represents the performance expectation for the learning workflow LW₂₂ 220.

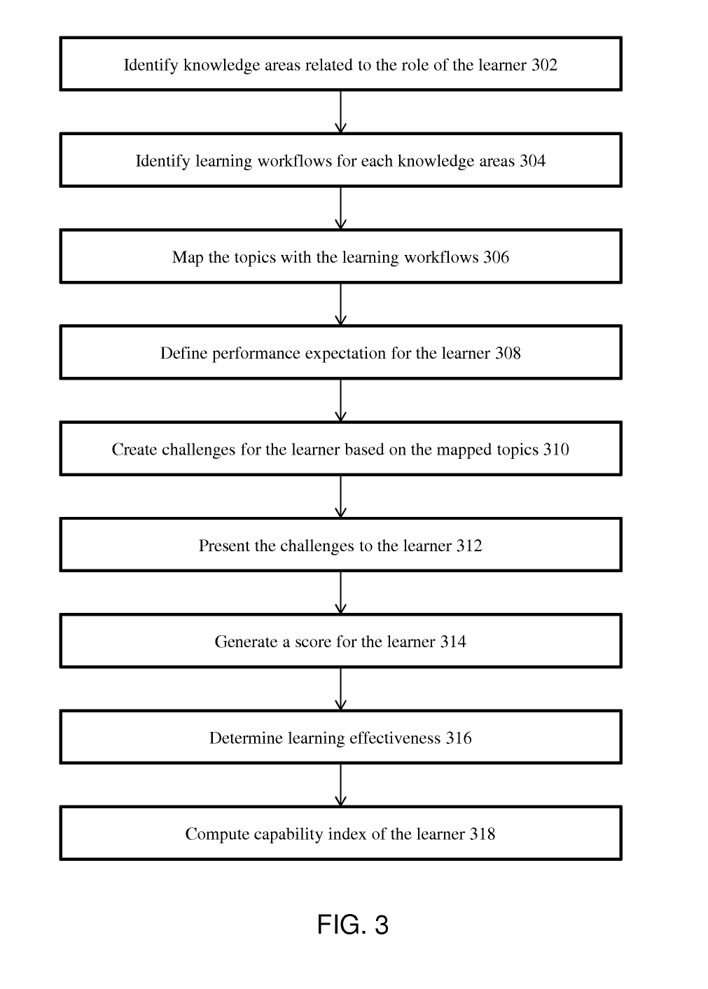

FIG. 3 is a flowchart, illustrating a method for learning and learning oriented assessment of at least one learner based on a role to be performed by the at least one learner, in accordance with an embodiment of the present invention. The different knowledge areas related to a role of the learner is identified, as in step 302. The role represents the actual training needs of the learner, the demonstrable abilities and the context where the learning would be applied. For example, a software engineer (role) in a software production unit (context) should have the abilities of coding, debugging, unit testing and understanding the design provided. In order to achieve this, a learning program is designed which maps to the demonstrable abilities (learning outcomes). The learning workflows for a particular knowledge area are then identified, as in step 304. After that, the relevant topics are mapped to the learning workflows, as in step 306. Each learning workflow consists of an ordered set of topics, the relationship if any, between the topics in the same or other learning workflows, the demonstrable skills achieved on learning the topic (here the learning outcomes are mapped to learning) and the learning aids (multimedia, text etc.) which are available for learning. The topics are arrived, based on the scope and criticality (Criticality is a function of relevance and retention) factors as shown in Table 1, Table 2 and Table 3. Table 1, 2 and 3 are exemplary tables and do not intend to limit the scope of the invention. The scope and the criticality factors are derived from Bloom's taxonomy and empirical evidences.

TABLE 1
Scope factors for topics

| Level (Bloom's | Numerical value for |
|---|---|
| taxonomy) | depth |
| Knowledge | 1 |
| Comprehension | 2 |
| Application | 3 |
| Analysis | 4 |
| Synthesis | 5 |

TABLE 2
Criticality (Relevance) factors for topics

| Relevance | Numerical value |
|---|---|
| Awareness | 1 |
| Good to know | 2 |
| Need to know | 3 |
| Must to know | 4 |
| Showstopper | 5 |

TABLE 3
Criticality (Retention) factors for topics

| Retention | Numerical value |
|---|---|
| Vocational | 1 |
| Immediate requirement | 2 |
| Current profile (Current job, | 3 |
| company etc.) | |
| Domain (throughout career) | 4 |
| Lifelong (throughout life) | 5 |

Referring back to FIG. 3, a performance expectation is defined at each learning workflow level, as in step 308. Performance expectation calculation comprises of three steps. At first step, the scope of coverage of topics is identified. Secondly, the criticality of topics in terms of Relevance and Retention is identified and at the final step, the performance expectation is computed based on scope, relevance and retention factor of the topics. This process is recursively followed for all the topics in the learning workflows. Then the performance expectation for the learning workflow is arrived, as per the formula given below:

LW_{Performance Expectation}=f(LW_{scope}, LW_{criticality})

Thereafter, different challenges are created for the learner, as in step 310 and when the learner will start learning, those challenges will be presented to the learner through a graphical user interface, as in step 312. The learner will be required to solve the challenges. These challenges are posed at each of the learning workflow levels. A challenge consists of a) Background which is the content that is to be learnt in order to solve the challenge and also exhibit the demonstrable skills b) A business scenario or a case study which helps in application of the concepts learnt instead of mere comprehension c) Interactions: A set of interactions which are to be solved by the learner. Each interaction in turn is provided with hints (scaffolding) to assist the learner in learning. The challenges are posed at three different levels namely a) Basic level b) Intermediate level c) Expert level. These levels are designed in increasing order of complexity and would ensure that the learner is able to retain the content learnt. The challenges and interactions may be represented as follows:

Challenge={Challenge id, {I₁, I₂, I₃, . . . In}, Tc}

Where, I₁ I₂, I₃, . . . In are interactions and T_{C}: Time allocated for a challenge

Interaction_{basic}={id, question, answer, max-marks, hint₁,hint₂,hint₃,score}

Interaction_{intermediate}={id, question, answer, max-marks , hint₁, hint₂, hint₃, score}

Interactionₑₓₚₑᵣₜ ={id, question, answer, max-marks, analogy, score}

The number of challenges and the levels are configured as per the learning needs. At the end of the completion of challenges a score is generated for the learner wherein the score is generated, as in step 314. The score would be analyzed to provide the feedback to the learner in terms of their capability. There is penalty or reduction in scores based on time taken to attempt a challenge and also the usage of hints. The learner is posed with challenges during learning making the assessment implied. In traditional systems, the content is provided first, followed by assessment. Also, the context, background and business context ensure that the learning outcomes are met instead of just reading the content as in existing systems. Thus this phase with the features mentioned (challenges, penalty) encapsulates the assessment so that the focus of the learner is on learning.

The learning effectiveness is determined from this score by comparing the score with the predefined performance expectation, as in step 316. The scores for the learning workflows of a knowledge area are collected and a consolidated score is arrived at. From this score, the learning assurance is provided to the learner by way of calculating the capability index, as in step 318. The learning scores (scores obtained by the learner while attempting the challenges) is compared against the performance expectation set for the learning workflows of a knowledge area. The result of comparison would provide whether a) the learner exceeded the expectations b) the learner met the expectations c) whether the learner did not meet the expectations. The capability values are captured based on how much expectation the learner is able to meet. For an example, the capability value for learner who exceeded expectation may be set as 5, similarly, the capability value for learner who just met the expectation may be set as 3 and capability value for learner who did not meet the expectation may be set as 1. This result is consolidated and summed to arrive at the capability index as below:

Cᵢ(Capability index)=ΣCapability value/ΣMaximum capability value

The capability index is a value between 0 and 1. Various inferences can be drawn based on the environment where the idea is applied. A sample inference is shown in table 4 which is given only for understanding purpose and doesn't intend to limit the scope of the invention.

TABLE 4
Sample inference of capability index values

| Capability index | Capability inference |
|---|---|
| 0.85 and above | Excellent |
| 0.65-0.84 | Good |
| 0.5-0.64 | Average |
| <0.5 | Needs improvement |

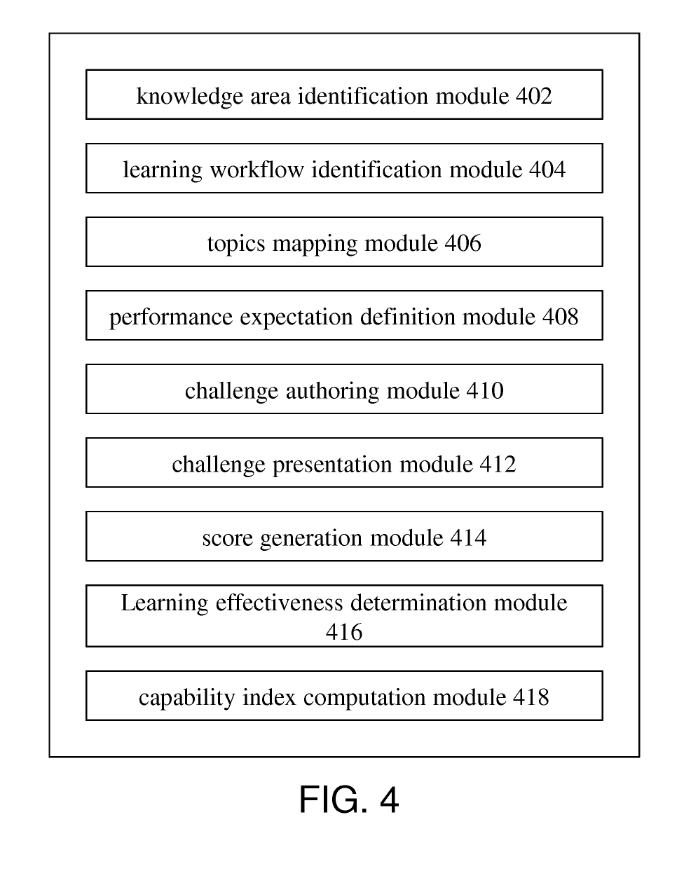

FIG. 4 is a block diagram illustrating a system for learning and learning oriented assessment of at least one learner based on a role to be performed by the at least one learner, in accordance with an embodiment of the present invention. The system includes a knowledge area identification module 402, a learning workflow identification module 404, a topics mapping module 406, a performance expectation definition module 408, a challenge authoring module 410, a challenge presentation module 412, a score generation module 414, a learning effectiveness determination module 416 and a capability index computation module 418. The knowledge area identification module 402 is configured to identify different knowledge areas related to the role of the learner. The learning workflow identification module 404 is configured to identify different learning workflows for each knowledge areas. The topics mapping module 406 is configured to map relevant topics for the learning workflows. Each learning workflow consists of an ordered set of topics, the relationship if any, between the topics in the same or other learning workflows, the demonstrable skills achieved on learning the topic (here the learning outcomes are mapped to learning) and the learning aids (multimedia, text etc.) which are available for learning. The topics are arrived, based on the scope and criticality (Criticality is a function of relevance and retention) factors as shown in table 1, 2 and 3 herein above. The performance expectation definition module 408 is configured to define performance expectation from the learner for each learning workflow based on the combination of scope, relevance and retention factors of the mapped topics. Performance expectation calculation comprises three steps. At first step, the scope of coverage of topics is identified. Secondly, the criticality of topics in terms of Relevance and Retention is identified and at the final step, the performance expectation is computed based on scope, relevance and retention factor of the topics. The challenge authoring module 410 is configured to create challenges for the learner. The challenge presentation module 412 is configured to present the challenges to the learner through a graphical user interface. These challenges are posed at each of the learning workflow levels. A challenge consists of a) Background which is the content that is to be learnt in order to solve the challenge and also exhibit the demonstrable skills b) A business scenario or a case study which helps in application of the concepts learnt instead of mere comprehension c) Interactions: A set of interactions which are to be solved by the learner. Each interaction in turn is provided with hints (scaffolding) to assist the learner in learning. The challenges are posed at three different levels namely a) Basic level b) Intermediate level c) Expert level. These levels are designed in increasing order of complexity and would ensure that the learner is able to retain the content learnt. The score generation module 414 is configured to generate a score for the learner. The score would be analyzed to provide the feedback to the learner in terms of their capability. There is penalty or reduction in scores based on time taken to attempt a challenge and also the usage of hints. The learning effectiveness determination module 416 is configured to determine learning effectiveness of the learner by comparing the generated score with the predefined performance expectation. The capability index computation module 418 is configured to compute the capability index of the learner by consolidating all the scores generated for different learning workflows under a specific knowledge area. The details of computation of capability index are described herein above.

The above mentioned description is presented to enable a person of ordinary skill in the art to make and use the invention and is provided in the context of the requirement for obtaining a patent. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

We claim:

1. A method, executed by one or more computing devices, for learning and learning oriented assessment of at least one learner based on a role to be performed by the at least one learner, the said method comprising:
identifying one or more knowledge areas related to the role of the at least one learner;
identifying one or more learning workflows related to each of the one or more knowledge areas;
mapping one or more topics to the one or more learning workflows;
defining a performance expectation for the at least one learner with respect to the one or more one or more learning workflows based on a combination of scope, relevance and retention factors of the one or more mapped topics;
creating, by at least one of the one or more computing devices, one or more challenges for the at least one learner based on the one or more topics mapped to the one or more learning workflows;
presenting, by at least one of the one or more computing devices, the one or more challenges to the at least one learner based on the one or more topics mapped to the one or more learning workflows;
generating, by at least one of the one or more computing devices, a score for the at least one learner with respect to each of the one or more topics; and
determining learning effectiveness of the at least one learner by comparing the score with the performance expectation.

2. The method as claimed in claim 1 further comprising computing a capability index for the one or more knowledge areas of the at least one learner by consolidating the score achieved in each of the one or more learning workflows .

3. The method as claimed in claim 1, wherein the one or more learning workflows comprise at least one of an ordered set of the one or more topics, a relationship between the one or more topics, one or more demonstrable skills achieved on learning the one or more topics and one or more learning aids.

4. The method as claimed in claim 1, wherein the one or more challenges comprise one or more relevant contents, a business scenario to solve and one or more interactions.

5. The method as claimed in claim 4, wherein the one or more interactions are provided with triggered assistance to help the at least one learner to solve the business scenario.

6. The method as claimed in claim 1, wherein the one or more challenges are grouped into one or more basic level challenges, one or more intermediate level challenges and one or more expert level challenges.

7. The method as claimed in claim 1, wherein the step of score generation tracks an amount of time taken and a number of the hints used by the at least one learner to solve the one or more challenges.

8. The method as claimed in claim 1, wherein the score indicates a capability value of the at least one learner with respect to the one or more learning workflows.

9. The method as claimed in claim 8, wherein the capability value is used to compute the capability index for the one or more knowledge areas.

10. A system for learning and learning oriented assessment of at least one learner based on a role to be performed by the at least one learner comprising:
a processor in operable communication with a processor readable storage medium, the processor readable storage medium containing one or more programming instructions whereby the processor is configured to implement:
a knowledge area identification module configured to identify one or more knowledge areas related to the role of the at least one learner;
a learning workflow identification module configured to identify one or more learning workflows related to each of the one or more knowledge areas of the at least one learner;
a topics mapping module configured to map one or more topics to the one or more learning workflows;
a performance expectation definition module configured to define a performance expectation for the at least one learner with respect to the one or more learning workflows based on a combination of scope, relevance and retention factors of the one or more mapped topics;
a challenge authoring module configured to create one or more challenges for the at least one learner based on the one or more topics mapped to the one or more learning workflows;
a challenge presentation module configured to present the one or more challenges to the at least one learner;
a score generation module configured to generate a score for the at least one learner with respect to each of the one or more topics; and
a learning effectiveness determination module configured to determine learning effectiveness of the at least one learner by comparing the score with the performance expectation.

11. The system as claimed in claim 10 further comprising a capability index computation module configured to compute a capability index of the at least one learner by consolidating the score achieved in each of the one or more topics.

12. The system as claimed in claim 10, wherein the one or more learning workflows comprise at least one of an ordered set of the one or more topics, a relationship between the one or more topics, one or more demonstrable skills achieved on learning the one or more topics and one or more learning aids.

13. The system as claimed in claim 10, wherein the one or more challenges comprise one or more relevant contents, a business scenario to solve and one or more interactions.

14. The system as claimed in claim 13, wherein the one or more interactions are provided with triggered assistance to help the at least one learner to solve the business scenario.

15. The system as claimed in claim 10, wherein the one or more challenges are grouped into one or more basic level challenges, one or more intermediate level challenges and one or more expert level challenges.

16. The system as claimed in claim 10, wherein the score generation module tracks an amount of time taken and a number of the hints used by the at least one learner to solve the one or more challenges.

17. The system as claimed in claim 10, wherein the score indicates a capability value of the at least one learner with respect to the one or more learning workflows.

18. The system as claimed in claim 17, wherein the capability value is used to compute the capability index.

19. A computer readable storage medium, that is not a signal, having computer executable instructions stored thereon for learning and learning oriented assessment of at least one learner based on a role to be performed by the at least one learner, the said instructions comprising:
instructions for identifying one or more knowledge areas related to the role of the at least one learner;
instructions for identifying one or more learning workflows related to each of the one or more knowledge areas for the role of the at least one learner;
instructions for mapping one or more topics to the one or more learning workflows;
instructions for defining a performance expectation for the at least one learner with respect to the one or more learning workflows based on a combination of scope, relevance and retention factors of the one or more mapped topics;
instructions for creating, by at least one of the one or more computing devices, one or more challenges for the at least one learner based on the one or more topics mapped to the one or more learning workflows;
instructions for presenting, by at least one of the one or more computing devices, the one or more challenges to the at least one learner based on the one or more topics mapped to the one or more learning workflows;
instructions for generating, by at least one of the one or more computing devices, a score for the at least one learner with respect to each of the one or more topics; and
instructions for determining learning effectiveness of the at least one learner by comparing the score with the performance expectation.

20. The computer readable storage medium as claimed in claim 19 further comprising instructions for computing a capability index of the at least one learner by consolidating the score achieved in each of the one or more learning workflows.

21. The computer readable storage medium as claimed in claim 19, wherein the one or more learning workflows comprise at least one of an ordered set of the one or more topics, a relationship between the one or more topics, one or more demonstrable skills achieved on learning the one or more topics and one or more learning aids.

22. The computer readable storage medium as claimed in claim 19, wherein the one or more challenges comprise one or more relevant contents, a business scenario to solve and one or more interactions.

23. The computer readable storage medium as claimed in claim 22, wherein the one or more interactions are provided with triggered assistance to help the at least one learner to solve the business scenario.

24. The computer readable storage medium as claimed in claim 19, wherein the score indicates a capability value of the at least one learner with respect to the one or more learning workflow.

25. The computer readable storage medium as claimed in claim 24, wherein the capability value is used to compute the capability index.
